(19) United States
(12) Patent Application Publication
(10) Pub. No.: US 2024/0200397 A1
(43) Pub. Date: Jun. 20, 2024

(54) FENESTRATION PANEL AND TRIM RETENTION SYSTEM

(71) Applicant: Andersen Corporation, Bayport, MN (US)

(72) Inventors: Todd Bruchu, Lake Elmo, MN (US); Justin Michael Depew, Stillwater, MN (US); Craig Michael Johnson, North Oaks, MN (US); Paul Michael Allan Morris, Roseville, MN (US); Jared Asa Shanholtzer, Saint Paul Park, MN (US)

(21) Appl. No.: 18/545,380

(22) Filed: Dec. 19, 2023

Related U.S. Application Data
(60) Provisional application No. 63/433,984, filed on Dec. 20, 2022.

(51) Int. Cl. E06B 3/58; E06B 1/70

(52) U.S. Cl. CPC E06B 3/5821; E06B 1/702

(57) ABSTRACT

Embodiments herein relate to systems and methods for securing panel members to frame members and fenestration systems including the same. In a first aspect, a fenestration system can be included having a panel assembly, a sill assembly, and one or more sill panel clips. The one or more sill panel clips can be disposed on a surface of the sill assembly such as an upper surface. The one or more sill panel clips can secure the panel assembly to the sill assembly. The fenestration system can also include a plurality of jamb members. The plurality of jamb members can include a first side jamb, a second side jamb, and a head jamb. The fenestration system can also include a plurality of jamb panel clips, wherein the plurality of jamb panel clips secure the panel assembly to the plurality of jamb members. Other embodiments are also included herein.

This application claims the benefit of U.S. Provisional Application No. 63/433,984 filed Dec. 20, 2022, the content of which is herein incorporated by reference in its entirety.

### FIELD

Embodiments herein relate to systems and methods for securing panel members to frame members and fenestration systems including the same.

### BACKGROUND

Fenestration units can include windows, patio doors, entry doors, and the like. Some fenestration units may include panel members, such as stationary panel members. For example, some door systems many include one or more stationary panel members. Typically, the various components of a fenestration unit should be securely fastened together. This is frequently done using fasteners, adhesives, and the like.

### SUMMARY

Embodiments herein relate to systems and methods for securing panel members to frame members and fenestration systems including the same. In a first aspect, a fenestration system can be included having a panel assembly, a sill assembly, and one or more sill panel clips. The one or more sill panel clips can be disposed on a surface of the sill assembly such as an upper surface. The one or more sill panel clips can secure the panel assembly to the sill assembly. The fenestration system can also include a plurality of jamb members. The fenestration system can also include a plurality of jamb panel clips, wherein the plurality of jamb panel clips secure the panel assembly to the plurality of jamb members.

In a second aspect, in addition to one or more of the preceding or following aspects, or in the alternative to some aspects, the jamb members can include receiving slots and the plurality of jamb panel clips can include one or more jamb retention hooks configured to fit within the receiving slots securing the plurality of jamb panel clips to the plurality of jamb members.

In a third aspect, in addition to one or more of the preceding or following aspects, or in the alternative to some aspects, a portion of the one or more jamb retention hooks can be angled with respect to a bottom surface of the plurality of jamb panel clips by 10 to 170 degrees.

In a fourth aspect, in addition to one or more of the preceding or following aspects, or in the alternative to some aspects, the jamb panel clips can include a trim retention element.

In a fifth aspect, in addition to one or more of the preceding or following aspects, or in the alternative to some aspects, the trim retention element can include a snap-fit mechanism.

In a sixth aspect, in addition to one or more of the preceding or following aspects, or in the alternative to some aspects, the trim retention element can include a dovetail snap fastener.

In a seventh aspect, in addition to one or more of the preceding or following aspects, or in the alternative to some aspects, further can include a trim piece, wherein the trim piece can be engaged with the trim retention element.

In an eighth aspect, in addition to one or more of the preceding or following aspects, or in the alternative to some aspects, the trim piece can include a trim stop.

In a ninth aspect, in addition to one or more of the preceding or following aspects, or in the alternative to some aspects, the panel assembly can include a panel and a sill panel filler, wherein the sill panel filler can be fastened to a bottom of the panel.

In a tenth aspect, in addition to one or more of the preceding or following aspects, or in the alternative to some aspects, the panel can include a stationary door panel.

In an eleventh aspect, in addition to one or more of the preceding or following aspects, or in the alternative to some aspects, the one or more sill panel clips can secure the panel assembly to the sill assembly preventing movement of a bottom of the panel assembly in a direction perpendicular to a lengthwise axis of the panel assembly.

In a twelfth aspect, in addition to one or more of the preceding or following aspects, or in the alternative to some aspects, the panel assembly can include a central projection, wherein the central projection can be disposed on a bottom side of the panel assembly and wherein the central projection can be configured to at least partially fit within the one or more sill panel clips.

In a thirteenth aspect, in addition to one or more of the preceding or following aspects, or in the alternative to some aspects, the one or more sill panel clips can include a raised stop member, wherein the raised stop member can be configured to prevent movement of the central projection to the interior side of the sill assembly.

In a fourteenth aspect, in addition to one or more of the preceding or following aspects, or in the alternative to some aspects, the plurality of jamb members can be formed with a pultrusion and/or extrusion and define one or more internal hollows.

In a fifteenth aspect, in addition to one or more of the preceding or following aspects, or in the alternative to some aspects, the jamb members can include a receiving aperture and the plurality of jamb panel clips can include a projection, wherein the projection can be configured to be inserted into the receiving aperture.

In a sixteenth aspect, in addition to one or more of the preceding or following aspects, or in the alternative to some aspects, the projection can include a pin.

In a seventeenth aspect, in addition to one or more of the preceding or following aspects, or in the alternative to some aspects, the system can further include a fastener, wherein the fastener can be driven through the jamb panel clip into the jamb member at an angle with respect to a plane of the panel.

In an eighteenth aspect, in addition to one or more of the preceding or following aspects, or in the alternative to some aspects, the fastener can include a screw.

In a nineteenth aspect, in addition to one or more of the preceding or following aspects, or in the alternative to some aspects, the plurality of jamb panel clips can be formed of a metal, a polymer, or a composite.

In a twentieth aspect, in addition to one or more of the preceding or following aspects, or in the alternative to some aspects, the one or more sill panel clips can be formed of a metal, a polymer, or a composite.

In a twenty-first aspect, in addition to one or more of the preceding or following aspects, or in the alternative to some aspects, the fenestration system lacks fasteners passing through the plurality of jamb members and into the panel assembly.

In a twenty-second aspect, in addition to one or more of the preceding or following aspects, or in the alternative to some aspects, the sill assembly and the plurality of jamb members form a door frame.

In a twenty-third aspect, in addition to one or more of the preceding or following aspects, or in the alternative to some aspects, the fenestration system can be an entry door system.

In a twenty-fourth aspect, in addition to one or more of the preceding or following aspects, or in the alternative to some aspects, the plurality of jamb members include a first side jamb, a second side jamb, and a head jamb.

In a twenty-fifth aspect, a method for securing a panel within a fenestration frame assembly can be included. The method can include attaching one or more sill panel clips onto a sill assembly, setting a panel assembly into an opening defined by the sill assembly and a plurality of jamb members thereby engaging the panel assembly with the one or more sill panel clips, and securing the panel assembly in the opening by fastening a plurality of jamb panel clips to the plurality of jamb members and the panel assembly.

In a twenty-sixth aspect, in addition to one or more of the preceding or following aspects, or in the alternative to some aspects, setting the panel assembly into the opening includes pivoting the panel assembly into the opening defined by the sill assembly and the jamb members.

In a twenty-seventh aspect, in addition to one or more of the preceding or following aspects, or in the alternative to some aspects, securing the panel assembly in the opening includes inserting a retention hook of the jamb panel clips into a slot of the jamb members and fastening the jamb panel clips to the panel assembly.

In a twenty-eighth aspect, in addition to one or more of the preceding or following aspects, or in the alternative to some aspects, securing the panel assembly in the opening includes inserting a retention hook of the plurality of jamb panel clips into an inward facing slot on the plurality of jamb members and inserting a fastener through the plurality of jamb panel clips into the panel.

In a twenty-ninth aspect, in addition to one or more of the preceding or following aspects, or in the alternative to some aspects, securing the panel assembly in the opening includes inserting a retention hook of a jamb panel clip into an inward facing slot on a jamb member, pivoting the jamb panel clip toward the panel to contact the panel, and inserting a fastener through the jamb panel clip into the panel.

In a thirtieth aspect, in addition to one or more of the preceding or following aspects, or in the alternative to some aspects, securing the panel assembly in the opening includes inserting a projection of the jamb panel clips into a receiving aperture of the jamb members and inserting a fastener through the jamb panel clip into the panel. In a thirty-first aspect, in addition to one or more of the preceding or following aspects, or in the alternative to some aspects, the projection can include a pin.

In a thirty-second aspect, in addition to one or more of the preceding or following aspects, or in the alternative to some aspects, the panel assembly can include a panel and a sill panel filler, wherein the sill panel filler can be fastened to a bottom of the panel. In a thirty-third aspect, in addition to one or more of the preceding or following aspects, or in the alternative to some aspects, the panel can include a stationary door panel.

In a thirty-fourth aspect, in addition to one or more of the preceding or following aspects, or in the alternative to some aspects, the method can further include attaching a trim piece to the jamb panel clips.

In a thirty-fifth aspect, in addition to one or more of the preceding or following aspects, or in the alternative to some aspects, the fenestration frame assembly can be a door frame assembly.

In a thirty-fifth aspect, in addition to one or more of the preceding or following aspects, or in the alternative to some aspects, the fenestration frame assembly can be a door frame assembly.

In a thirty-sixth aspect, a fenestration system can be included having a panel and and one or more jamb members. The one or more jamb members can include one or more receiving slots. The system can also include one or more jamb panel clips, wherein the one or more jamb panel clips secure the panel to the one or more jamb members. The one or more jamb panel clips can include one or more jamb retention hooks. The one or more jamb retention hooks can be configured to fit within the one or more receiving slots securing the one or more jamb panel clips to the one or more jamb members.

In a thirty-seventh aspect, in addition to one or more of the preceding or following aspects, or in the alternative to some aspects, a portion of the one or more jamb retention hooks can be angled with respect to a bottom surface of the one or more jamb panel clips by 10 to 170 degrees.

In a thirty-eighth aspect, in addition to one or more of the preceding or following aspects, or in the alternative to some aspects, the one or more jamb panel clips can further include a trim retention element.

In a thirty-ninth aspect, in addition to one or more of the preceding or following aspects, or in the alternative to some aspects, the trim retention element can include a snap-fit mechanism.

In a fortieth aspect, in addition to one or more of the preceding or following aspects, or in the alternative to some aspects, the trim retention element can include a dovetail snap fastener.

In a forty-first aspect, in addition to one or more of the preceding or following aspects, or in the alternative to some aspects, the system can further include a trim piece, wherein the trim piece can be engaged with the trim retention element.

In a forty-second aspect, in addition to one or more of the preceding or following aspects, or in the alternative to some aspects, the trim piece can include a trim stop.

In a forty-third aspect, in addition to one or more of the preceding or following aspects, or in the alternative to some aspects, the one or more jamb members can be formed with a pultrusion and/or extrusion and define one or more internal hollows.

In a forty-fourth aspect, in addition to one or more of the preceding or following aspects, or in the alternative to some aspects, they system further can include a fastener, wherein the fastener can be driven through the jamb panel clip into the jamb member at an angle with respect to a plane of the panel.

In a forty-fifth aspect, in addition to one or more of the preceding or following aspects, or in the alternative to some aspects, the fastener can include a screw.

In a forty-sixth aspect, in addition to one or more of the preceding or following aspects, or in the alternative to some aspects, the one or more jamb panel clips can be formed of a metal, a polymer, or a composite.

In a forty-seventh aspect, in addition to one or more of the preceding or following aspects, or in the alternative to some aspects, the fenestration system lacks fasteners passing through the one or more jamb members and into the panel.

In a forty-eighth aspect, in addition to one or more of the preceding or following aspects, or in the alternative to some aspects, the one or more jamb members include a first side jamb, a second side jamb, and a head jamb.

In a forty-ninth aspect, in addition to one or more of the preceding or following aspects, or in the alternative to some aspects, the one or more jamb members include a first side jamb, a second side jamb, a bottom head jamb, and a top head jamb.

In a fiftieth aspect, in addition to one or more of the preceding or following aspects, or in the alternative to some aspects, the fenestration system can be an entry door system.

In a fifty-first aspect, a fenestration system can be included having a panel with one or more receiving slots, one or more jamb members, and one or more jamb panel clips. The one or more jamb panel clips can secure the panel to the one or more jamb members. The one or more jamb panel clips can include one or more panel retention hooks, wherein the one or more panel retention hooks can be configured to fit within the one or more receiving slots securing the one or more jamb panel clips to the panel.

In a fifty-second aspect, in addition to one or more of the preceding or following aspects, or in the alternative to some aspects, a portion of the one or more panel retention hooks can be angled with respect to a bottom surface of the one or more jamb panel clips by 10 to 170 degrees.

In a fifty-third aspect, in addition to one or more of the preceding or following aspects, or in the alternative to some aspects, the fenestration system can further include a sill assembly and one or more sill panel clips. The one or more sill panel clips can be disposed on an upper surface of the sill assembly and the one or more sill panel clips can secure the panel to the sill assembly.

In a fifty-fourth aspect, in addition to one or more of the preceding or following aspects, or in the alternative to some aspects, the one or more sill panel clips secure the panel to the sill assembly preventing movement of a bottom of the panel in a direction perpendicular to a lengthwise axis of the panel.

In a fifty-fifth aspect, in addition to one or more of the preceding or following aspects, or in the alternative to some aspects, the panel further can include a central projection, wherein the central projection can be disposed on a bottom side of the panel, and wherein the central projection can be configured to at least partially fit within the one or more sill panel clips.

In a fifty-sixth aspect, in addition to one or more of the preceding or following aspects, or in the alternative to some aspects, the one or more sill panel clips can include a raised stop member, wherein the raised stop member can be configured to prevent movement of the central projection to the interior side of the sill assembly.

In a fifty-seventh aspect, in addition to one or more of the preceding or following aspects, or in the alternative to some aspects, the one or more jamb panel clips further can include a trim retention element.

In a fifty-eighth aspect, in addition to one or more of the preceding or following aspects, or in the alternative to some aspects, the trim retention element can include a snap-fit mechanism.

In a fifty-ninth aspect, in addition to one or more of the preceding or following aspects, or in the alternative to some aspects, the trim retention element can include a dovetail snap fastener.

In a sixtieth aspect, in addition to one or more of the preceding or following aspects, or in the alternative to some aspects, further can include a trim piece, wherein the trim piece can be engaged with the trim retention element.

In a sixty-first aspect, in addition to one or more of the preceding or following aspects, or in the alternative to some aspects, the trim piece can include a trim stop.

In a sixty-second aspect, in addition to one or more of the preceding or following aspects, or in the alternative to some aspects, the panel the fenestration system can further include a panel and a sill panel filler, wherein the sill panel filler can be fastened to a bottom of the panel.

In a sixty-third aspect, in addition to one or more of the preceding or following aspects, or in the alternative to some aspects, the panel further can include a stationary door panel.

In a sixty-fourth aspect, in addition to one or more of the preceding or following aspects, or in the alternative to some aspects, the one or more jamb members can be formed with a pultrusion and/or extrusion and define one or more internal hollows.

In a sixty-fifth aspect, in addition to one or more of the preceding or following aspects, or in the alternative to some aspects, further can include a fastener, wherein the fastener can be driven through the jamb panel clip into the jamb member at an angle with respect to a plane of the panel.

In a sixty-sixth aspect, in addition to one or more of the preceding or following aspects, or in the alternative to some aspects, the fastener can include a screw.

In a sixty-seventh aspect, in addition to one or more of the preceding or following aspects, or in the alternative to some aspects, the one or more jamb panel clips can be formed of a metal, a polymer, or a composite.

In a sixty-eighth aspect, in addition to one or more of the preceding or following aspects, or in the alternative to some aspects, the fenestration system lacks fasteners passing through the one or more jamb members and into the panel.

In a sixty-ninth aspect, in addition to one or more of the preceding or following aspects, or in the alternative to some aspects, the fenestration system can be an entry door system.

In a seventieth aspect, in addition to one or more of the preceding or following aspects, or in the alternative to some aspects, the one or more jamb members include a first side jamb, a second side jamb, and a head jamb.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE FIGURES

Aspects may be more completely understood in connection with the following figures (FIGS.), in which:

FIG. 1 is a simplified front elevation view of an entry door system in accordance with various embodiments herein.

FIG. 2 is a perspective view of a sill panel clip in accordance with various embodiments herein.

FIG. 3 is a side view of a sill panel clip in accordance with various embodiments herein.

FIG. 4 is a cross-sectional view of a sill assembly and sill panel clip in accordance with various embodiments herein.

FIG. 5 is a cross-sectional view of a sill panel clip attached to a sill assembly in accordance with various embodiments herein.

FIG. 6 is a cross-sectional view of a portion of a fenestration system in accordance with various embodiments herein.

FIG. 7 is a perspective view of a jamb panel clip in accordance with various embodiments herein.

FIG. 8 is a side view of a jamb panel clip in accordance with various embodiments herein.

FIG. 9 is a bottom perspective view of a jamb panel clip in accordance with various embodiments herein.

FIG. 10 is a cross-sectional view of a portion of a fenestration system in accordance with various embodiments herein.

FIG. 11 is a cross-sectional view of a portion of a fenestration system in accordance with various embodiments herein.

FIG. 12 is a cross-sectional view of a portion of a fenestration system in accordance with various embodiments herein.

FIG. 13 is a cross-sectional view of a panel intersecting a jamb member in accordance with various embodiments herein.

FIG. 14 is a cross-sectional view of a panel intersecting a jamb member in accordance with various embodiments herein.

FIG. 15 is a cross-sectional view of a panel intersecting a jamb member in accordance with various embodiments herein.

While embodiments are susceptible to various modifications and alternative forms, specifics thereof have been shown by way of example and drawings, and will be described in detail. It should be understood, however, that the scope herein is not limited to the particular aspects described. On the contrary, the intention is to cover modifications, equivalents, and alternatives falling within the spirit and scope herein.

### DETAILED DESCRIPTION

Fenestration units can include windows, patio doors, entry doors, and the like. As referenced above, some fenestration units include panel members, such as stationary panel members. For example, some door systems include one or more stationary panel members. Generally, the various components of a fenestration unit should be securely fastened together including any panel members thereof. However, some configurations of fenestration units can make it more difficult to fasten components together than others. For example, in a typical scenario panel members may be secured into a frame by passing a fastener through a frame member from the outside and then into the panel member. However, this requires access to the outside of the frame member. Some configurations of fenestrations do not allow for easy access to the outside of the frame members making insertion of fasteners in from the side difficult. Further, after installation of the fenestration unit, the sides of frame members may be inaccessible rendering it very difficult or impossible to remove panel members for purposes of replacement or servicing.

Embodiments herein include components, systems, and methods for securing panel members within a frame in a convenient and secure manner. Notably, embodiments herein can include allow for securing a panel within a frame without passing in fasteners from the side. Rather, embodiments herein can allow for securing a panel within a frame only requiring access from an interior (or in some embodiments an exterior side) of the fenestration unit. Thus, access from the side is not required. As such, embodiments herein can allow for the installation, removal, and/or replacement of a panel without needing access to the outer side of the frame member, which may be difficult or impossible with some configurations and especially after the fenestration unit has been installed.

In an embodiment, a method for securing a panel within a fenestration frame assembly is included. The method can include attaching one or more sill panel clips onto a sill assembly, setting a panel assembly into an opening defined by the sill assembly and a plurality of jamb members thereby engaging the panel assembly with the one or more sill panel clips. The method can further include securing the panel assembly in the opening by fastening a plurality of jamb panel clips to the plurality of jamb members and the panel assembly, such as from an interior side of the fenestration frame assembly.

In an embodiment, a fenestration system is included. The fenestration system can include a panel assembly, a sill assembly, and one or more sill panel clips. The one or more sill panel clips can be disposed on an upper surface of the sill assembly. The panel assembly can be set into the frame from an interior side of the fenestration unit and down upon the sill panel clip(s). The one or more sill panel clips can secure the panel assembly to the sill assembly. The fenestration system can further include a plurality of jamb members. The plurality of jamb members can include a first side jamb, a second side jamb, and a head jamb. The fenestration system can further include a plurality of jamb panel clips. The plurality of jamb panel clips can be installed from an interior side of the fenestration unit and can secure the panel assembly to the plurality of jamb members.

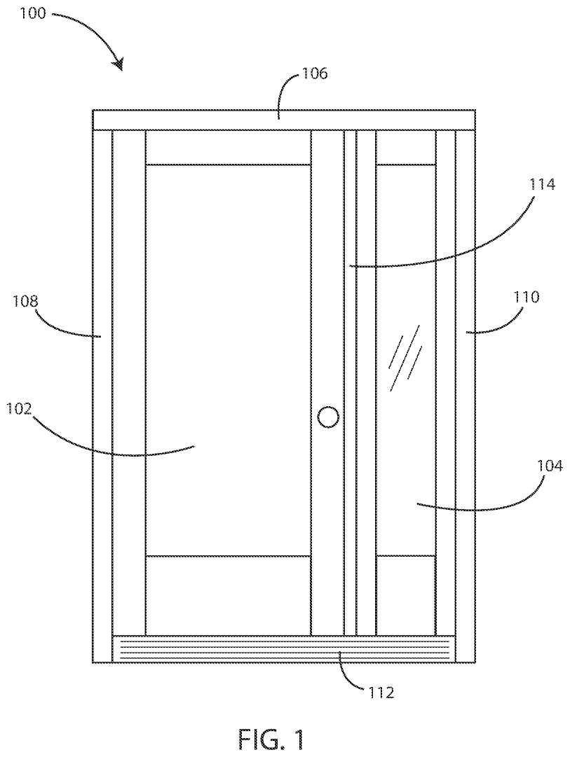

It will be appreciated that components, system, and methods herein can be used with various fenestration systems including, but not limited to, entry door systems, patio door systems, windows, and the like. Referring now to FIG. 1, a simplified front elevation view is shown of a fenestration system 100 in accordance with various embodiments herein. The fenestration system 100 can include an entry door 102 and a side light 104. The framing of the fenestration system 100 (or entry door system) can include a head jamb 106, a first side jamb 108, a second side jamb 110, and a sill assembly 112. In this example, a mull post 114 can also be included between the entry door 102 and the side light 104. The sill panel clips and jamb panel clips herein can be used to aid in securing panels and/or glazing units into frames and/or one or more frame components of fenestration systems.

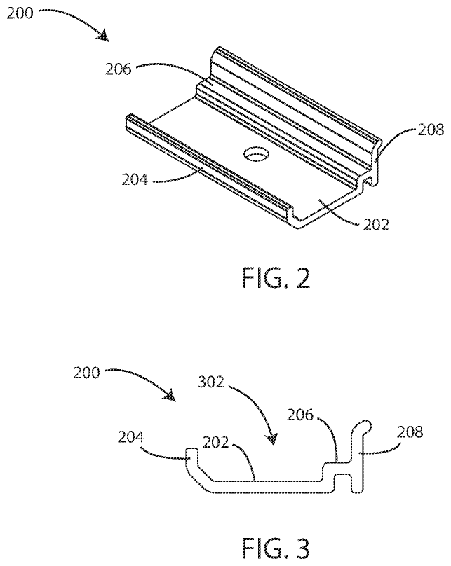

Referring now to FIG. 2, a perspective view of a sill panel clip 200 is shown in accordance with various embodiments herein. The sill panel clip 200 includes a bottom portion 202 and a front lip 204. The one or more sill panel clips 200 also includes a panel shelf 206. The one or more sill panel clips 200 also includes a raised stop member 208. In various embodiments, the sill panel clip 200 is formed of a metal, a polymer, or a composite.

In various embodiments, the sill panel clip 200 secures a panel assembly (described further below) to a sill assembly (also described further below) preventing movement of a bottom of the panel assembly in a direction perpendicular to a lengthwise axis of the panel assembly As such, the sill panel clip 200 can prevent movement of the bottom of the panel assembly along an axis extending between the interior side of the fenestration system and the exterior side of the fenestration assembly—illustrated below. Various numbers of sill panel clips 200 can be used. In some embodiments, only a single sill panel clip 200 may be used. In other embodiments, a plurality of sill panel clips 200 can be used such as 2, 3, 4, 5, or more. In various embodiments, the sill panel clip(s) 200 are disposed on a surface of the sill assembly, such as an upper surface of the sill assembly. In various embodiments, the raised stop member 208 of the sill panel clip 200 can be configured to prevent movement of the panel assembly to the interior side of the sill assembly.

Referring now to FIG. 3, a side view of a sill panel clip 200 is shown in accordance with various embodiments herein. The one or more sill panel clips 200 include a bottom portion 202, a front lip 204, a panel shelf 206, and a raised stop member 208. Taken together, the elements of the sill panel clip 200 can be seen to form a receiving channel 302 that can interface with one or more parts of the panel assembly and retain the same.

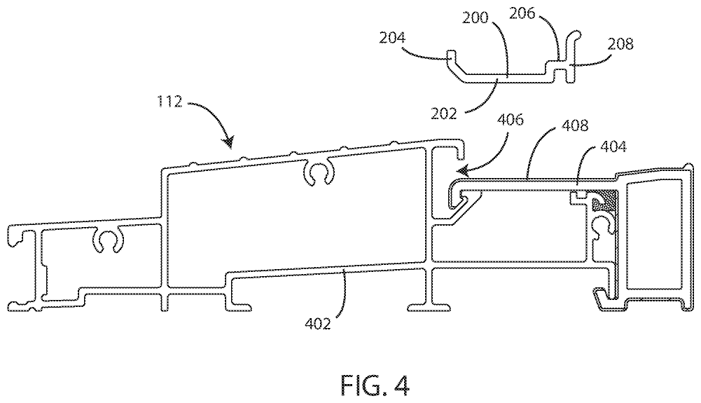

Referring now to FIG. 4, a cross-sectional view of a sill assembly 112 and sill panel clip 200 is shown in accordance with various embodiments herein. The sill panel clip 200 includes a bottom portion 202. The sill panel clips 200 also includes a front lip 204. The one or more sill panel clips 200 also includes a panel shelf 206. The one or more sill panel clips 200 also includes a raised stop member 208. The fenestration system also includes a sill assembly 112. The sill assembly 112 includes an exterior portion 402. The sill assembly 112 also includes an interior portion 404. The sill assembly 112 also includes an upper surface 408. The sill assembly 112 also defines a clip pocket 406. The clip pocket 406 can be used to receive a portion of the sill panel clip, such as the front lip 204 thereof.

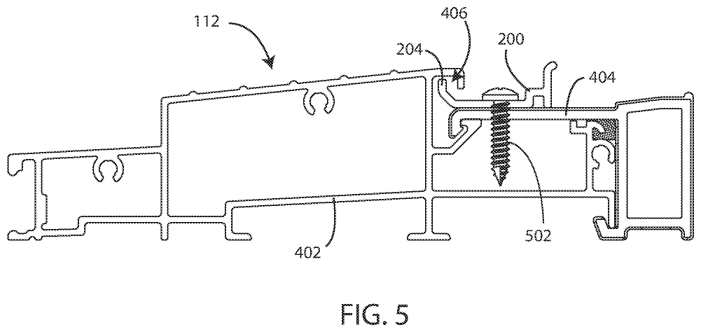

Referring now to FIG. 5, a cross-sectional view of a sill panel clip 200 attached to a sill assembly 112 is shown in accordance with various embodiments herein. The fenestration system also includes a sill assembly 112. The sill assembly 112 includes an exterior portion 402 and an interior portion 404. The sill panel clip 200 includes a front lip 204, which has been inserted into the clip pocket 406.

In FIG. 5, the fenestration system is also shown to include a fastener 502 securing the sill panel clip 200 down onto a surface of the sill assembly 112, such as the upper surface 408 of the sill assembly 112. The fastener 502 can be a screw. However, other fasteners are also contemplated herein including, but not limited to, rivets, bolts, nails, and the like. In some embodiments, a fastener 502 can be omitted and the sill panel clip 200 can be adhesively bonded down onto the upper surface 408 of the sill assembly 112.

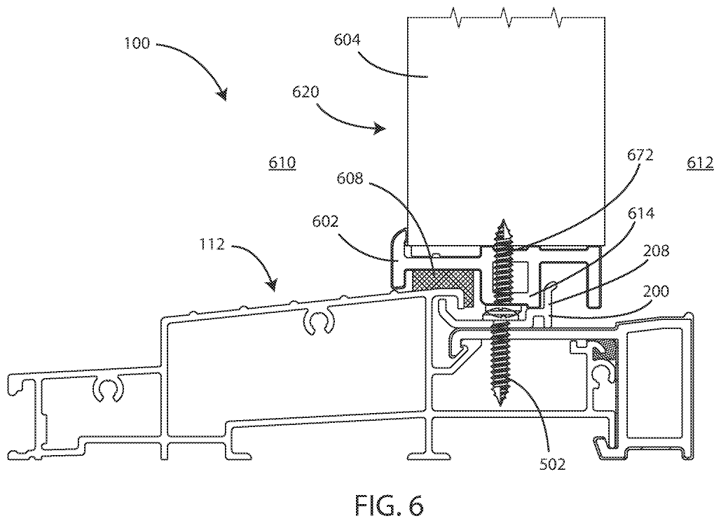

Referring now to FIG. 6, a cross-sectional view of a portion of a fenestration system 100 is shown in accordance with various embodiments herein. FIG. 6 illustrates an exterior side 610 and an interior side 612 of the fenestration system 100 (such as may correspond to an interior of a structure and an exterior of a structure after installation of the fenestration system within a rough opening of the structure). As previously described, embodiments herein can allow installation of a panel assembly while only requiring access to the fenestration frame from an interior side 612 of the fenestration system 100. However, in some embodiments, the panel assembly could also be inserted from an exterior side 610 of the fenestration system 100. The fenestration system 100 includes a one or more sill panel clips 200. In this example, the one or more sill panel clips 200 includes a raised stop member 208. The fenestration system 100 also includes a sill assembly 112. The fenestration system 100 also includes a fastener 502 securing the sill panel clip 200 to the sill assembly 112. The fenestration system 100 also includes weather stripping 608. It will be appreciated that many discrete pieces of weather stripping 608 can be used herein.

The fenestration system 100 also includes a panel assembly 620. In this example, the panel assembly 620 includes a panel 604 and a sill panel filler 602. In various embodiments, the panel 604 and sill panel filler 602 can be physically integrated. In various embodiments, the sill panel filler 602 can be fastened to a bottom of a panel 604 using a mechanical fastener and/or an adhesive. In this example, the sill panel filler 602 is secured to the bottom of the panel 604 using fastener 672.

The panel assembly 620 can include a projection 614, such as a central projection. The projection 614 can interface with and be retained by the sill panel clip 200. In various embodiments, the projection 614 can be disposed on a bottom side of a panel assembly 620, such as on the bottom side of the sill panel filler 602. In various embodiments, the projection 614 can be configured to engage or otherwise at least partially fit within one or more sill panel clips 200. In operation, the projection 614 or another structure on the bottom of the panel assembly 620 can engage with the sill panel clips 200, such as the raised stop member 208 of the sill panel clip 200. When the panel assembly 620 engages with the sill panel clip 200, it prevents movement and/or limits movement of the panel assembly 620 toward the interior side 612 of the fenestration system 100. Thus, the one or more sill panel clips 200 secure the panel assembly 620 to the sill assembly 112 preventing and/or limiting movement of a bottom of the panel assembly 620 in a direction perpendicular to a lengthwise axis of the panel assembly 620 (a direction along an axis interconnecting the interior side 612 and the exterior side 610).

The panel 604 can be of various types. In various embodiments, the panel 604 can include a stationary door panel 604. The panel 604 can be formed of various materials including, but not limited to, wood, polymer, metal, composite, or the like. The panel 604 can be a solid panel or a hollow panel. In some embodiments, the panel 604 can include one or more glazing units. In some embodiments, the panel 604 can lack glazing units.

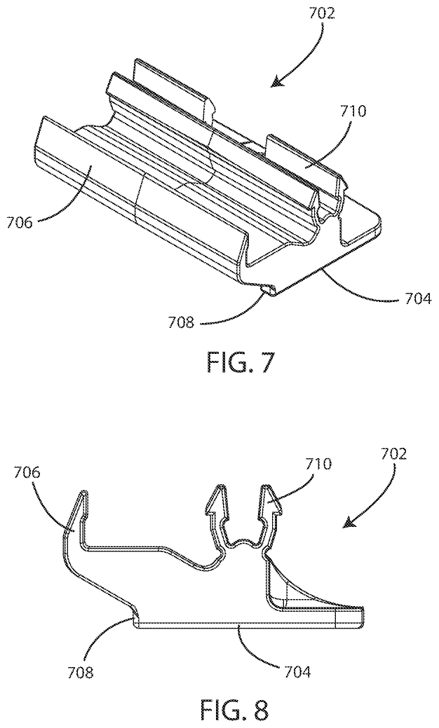

A plurality of jamb panel clips can be used to secure the panel assembly into the frame at the intersection between the panel assembly and the various jamb members such as the head jamb and the side jambs. In some embodiments, 2, 3, 4, 5, 6, 7, 8, 12, 16 or more jamb panel clips can be used, or a number of clips falling within a range between any of the foregoing. Referring now to FIG. 7, a perspective view of a jamb panel clip 702 is shown in accordance with various embodiments herein. The jamb panel clip 702 can include a bottom surface 704 and one or more jamb retention elements, such as jamb retention hooks 706. In some embodiments, the jamb panel clip 702 can also include a stop notch 708. In various embodiments, the jamb panel clip 702 can also include a trim retention element 710.

The jamb panel clip 702 can function to secure a panel assembly to one or more jamb members such as a side jamb and/or head jamb and, advantageously, can be installed while only requiring access to the interior side of the fenestration system (and/or the exterior side of the fenestration system in some embodiments). In various embodiments, the one or more jamb retention hooks 706 (and/or other projections) are configured to fit within receiving slots or some other type of aperture (a dovetail slot, t-slot, angled slot, hole, well, etc.) within the jamb members. In some embodiments, the receiving slots or apertures are disposed on a side of the jamb members facing the panel assembly. The jamb retention hooks 706 or other projection can thereby secure the jamb panel clip(s) 702 to the jamb members.

In various embodiments, an end portion of the one or more jamb retention hooks 706 can be angled with respect to a bottom surface 704 of the jamb panel clips 702 by 10 to 170 degrees, 45 to 135 degrees, or 70 to 110 degrees. For example, when angled between 70 to 110 degrees, the end portion of the one or more jamb retention hooks 706 can be largely perpendicular to the bottom surface 704. When inserted into the receiving slots of the jamb members and then rotated into position so that the bottom surface 704 is flat against a surface of the panel assembly, the end portion of the jamb retention hooks 706 can serve to retain the jamb retention hook 706 in the receiving slots of the jamb members. The jamb retention hook 706 portion can take on many different forms and shapes. However, in some embodiments, the retention hook can be omitted such as in some of the embodiments described below. Jamb panel clips herein can be formed of various materials. For example, in some embodiments, the jamb panel clip 702 can be formed of a metal, a polymer, or a composite.

Referring now to FIG. 8, a side view of a jamb panel clip 702 is shown in accordance with various embodiments herein. As before, the jamb panel clip 702 includes a bottom surface 704, one or more jamb retention hooks 706, a stop notch 708, and a trim retention element 710. In various embodiments, the trim retention element 710 can include a snap-fit mechanism. More specifically, in various embodiments, the trim retention element 710 can include a dovetail snap fastener. However, other types of trim retention elements are also contemplated herein including, but not limited to, other friction fit or snap fit mechanical mechanisms, magnetic retention elements, hook and loop (such as VELCRO) retention elements, and the like. While not intending to be bound by theory, it is believed that placement of the trim retention element 710 on the jamb panel clip 702 is advantageous as it allows for tight control of the distance between the jamb members and the trim piece(s) that get attached and between the panel and the trim pieces since the jamb panel clip 702 gets attached to both the jamb members and the panel. This can prevent unsightly gaps between the trim pieces and the jamb members and/or the panel.

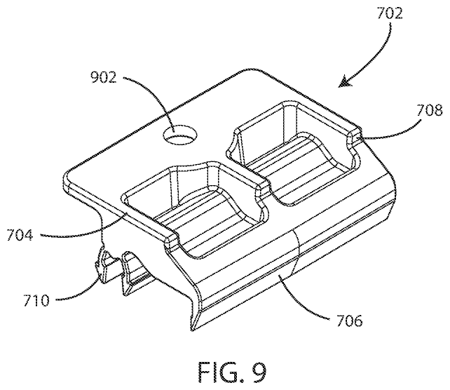

Referring now to FIG. 9, a bottom perspective view of a jamb panel clip 702 is shown in accordance with various embodiments herein. As shown, the jamb panel clip 702 can include a fastener aperture 902. As before, the jamb panel clip 702 includes a bottom surface 704, one or more jamb retention hooks 706, a stop notch 708, and a trim retention element 710.

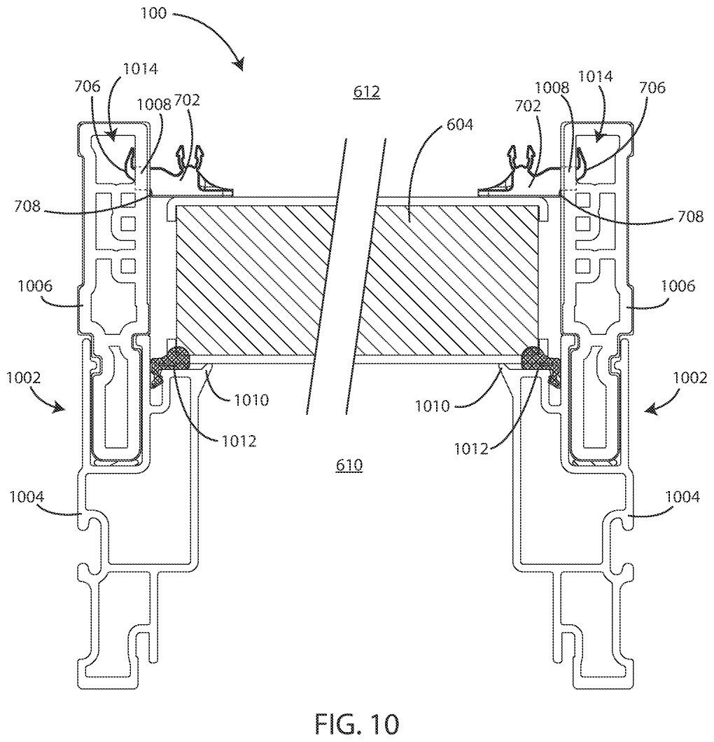

Referring now to FIG. 10, a cross-sectional view of a portion of a fenestration system 100 is shown in accordance with various embodiments herein. FIG. 10 shows an exterior side 610 (such as would be facing the exterior of a structure when the fenestration system 100 is installed). FIG. 10 shows an interior side 612 (such as would be facing the interior of a structure when the fenestration system 100 is installed). The panel assembly includes a panel 604. The fenestration system 100 includes one or more jamb panel clips 702, each including jamb retention hooks 706. In some embodiments, a number of discrete jamb panel clips 702, such as 2 to 20 or more, can be used with a particular jamb member (e.g., along a particular side of the frame). However, in some embodiments, a single long panel clip 702 can be used with a particular jamb member (e.g., a single long panel clip 702 along a particular side of the frame). The fenestration system 100 also includes a plurality of jamb members 1002. In this example, the plurality of jamb members 1002 include a jamb exterior portion 1004 and a jamb interior portion 1006. However, single piece jamb members are also contemplated herein. The plurality of jamb members 1002 also include receiving slots 1008 providing access to inner hollow 1014. In some cases, a single jamb member can include a single long receiving slot 1008. In other cases, a single jamb member can include a plurality of receiving slots 1008 such as 2 to 20 or more. The one or more jamb retention hooks 706 are configured to fit within the receiving slots 1008 securing the plurality of jamb panel clips 702 to the plurality of jamb members 1002. The stop notch 708 of the jamb panel clips 702 can fit against or adjacent to a surface of the jamb members 1002.

The jamb exterior portion 1004 can include an exterior stop 1010. On the exterior side 610, the panel 604 can be retained by the exterior stop 1010. On the interior side 612, the panel 604 can be retained by the jamb panel clips 702. The fenestration system can also include various portions of weather stripping 1012.

In various embodiments, the plurality of jamb members 1002 include can a first side jamb, a second side jamb, and a head jamb. In various embodiments, the plurality of jamb members 1002 can be formed with a pultrusion and/or an extrusion and can define one or more internal hollows. It will be appreciated, however, that in some embodiments jamb members 1002 herein may be a solid profile such as a solid piece of wood or another material without inner hollows. In such a case, slots or other types of apertures can be cut into the jamb members 1002.

In various embodiments, the sill assembly 112 and the plurality of jamb members 1002 form a door frame. In various embodiments, the fenestration system can be an entry door system. Frame members herein that can engage with jamb panel clips can also include mull posts and other framing elements.

In some embodiments, the fenestration system lacks fasteners passing through the plurality of jamb members 1002 and into the panel assembly 620 from the side. This can enable easier replacement and/or servicing of the panel assembly 620.

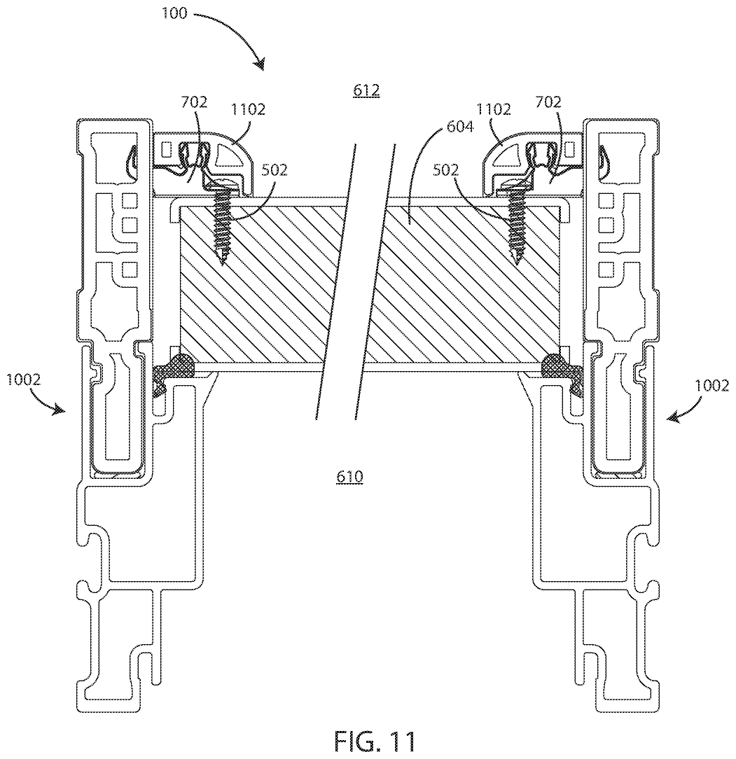

As described above, the end portion of the jamb retention hooks 706 can serve to retain the jamb retention hook 706 in the receiving slots of the jamb members 1002. Thus, the jamb retention hook 706 can prevent the jamb panel clip 702 from pulling out from the jamb member. Further, because the jamb panel clips 702 are secured or otherwise fastened to the panel 604 after installation, and because (as shown in FIGS. 10 and 11) the opposing jamb member 1002 (e.g., on the opposite side of the panel 604) is also secured to the panel 604 through an opposing jamb member 1002, the jamb members 1002 are prevented from flexing outward away from the panel 604.

After insertion into the receiving slots, the stop notch 708 can fit against an external surface of the jamb member 1002 adjacent the receiving slot 1008 of the jamb member 1002. For example, when the jamb panel clip 702 is installed (see, e.g., FIGS. 10 and 11), the stop notch 708 can be configured to rest against a surface of the jamb member 1002 (head jam, side jambs, etc.) that is adjacent the receiving slot 1008. Thus, the stop notch 708 can prevent the jamb panel clip 702 from moving farther toward/into the jamb member 1002. As referenced below with respect to FIG. 11, the jamb panel clip 702 can be secured to the panel 604 (such as with a fastener). Thus, the stop notch 708 can also prevent the panel 604 from moving toward the jamb member 1002. Similarly, the stop notch 708 can prevent the frame member 1002 from flexing inward toward the panel 604. Between the jamb retention hook 706 and the stop notch 708, and the jamb panel clip 702 being secured to the panel, the frame members 1002 and panel 604 are all fixed in position with respect to one another in a plane parallel to the panel 604. Further, the jamb panel clips 702 secure the panel 604 to the frame members preventing movement of the panel 604 in a direction perpendicular to a lengthwise axis of the panel 604.

In the view shown in FIG. 10, the jamb panel clips 702 are in position ready to be fastened to the stationary door panel 604. Referring now to FIG. 11, a cross-sectional view of a portion of a fenestration system 100 is shown in accordance with various embodiments herein. In this view the jamb panel clips 702 are fastened to the stationary door panel 604 with fasteners 502. As before with FIG. 10, FIG. 11 shows an exterior side 610 an interior side 612 and the fenestration system 100 includes fasteners 502, a panel 604, jamb panel clips 702, and jamb members 1002. In FIG. 11, the fenestration system also includes a trim piece 1102. The trim piece 1102 can be engaged with and retained by a trim retention element 710 through a snap-fit or compression-fit type mechanism which can allow convenient removal for servicing or replacement purposes. In various embodiments, the trim piece 1102 can include a trim stop.

In the embodiment of FIG. 11, the jamb panel clips 702 fit into slots on the adjacent frame member and are then fastened to the panel. However, it will be appreciated that the positioning can be reversed such that the jamb panel clips 702 can fit into slots or other apertures on the panel and then be fastened to the adjacent frame member using a fastener. Thus, in some embodiments, a fenestration system is included having a panel assembly, a plurality of jamb members, and one or more sill panel clips. The fenestration system can also include a plurality of jamb panel clips, wherein the plurality of jamb panel clips secure the panel assembly to the plurality of jamb members. In this configuration, the panel can include one or more receiving slots or apertures and the plurality of jamb panel clips can include one or more jamb retention hooks or other features configured to fit within the receiving slots securing the plurality of jamb panel clips to the panel. Then the jamb panel clips can be fastened to the jamb members using fastener(s).

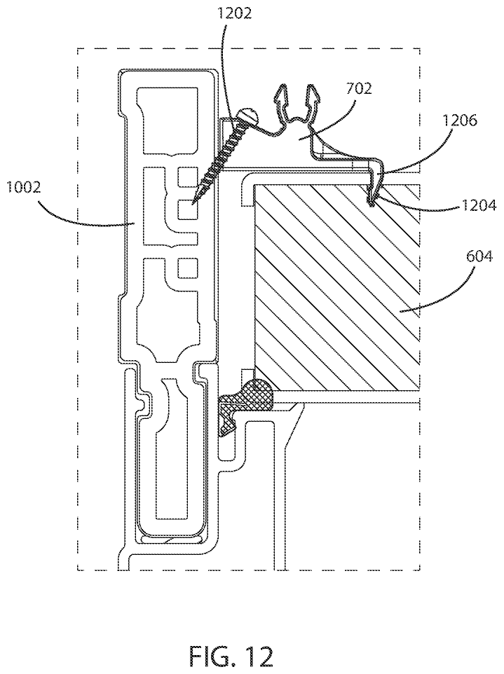

Referring now to FIG. 12, a cross-sectional view of a portion of a fenestration system is shown in accordance with various embodiments herein. In this example, the positioning of the retention hook and slots are different than in that of FIG. 11. In this example the jamb panel clip 702 is fastened to the jamb member 1002 with fastener 1202. A panel retention hook 1206 of the jamb panel clip 702 fits within a slot 1204 in panel 604.

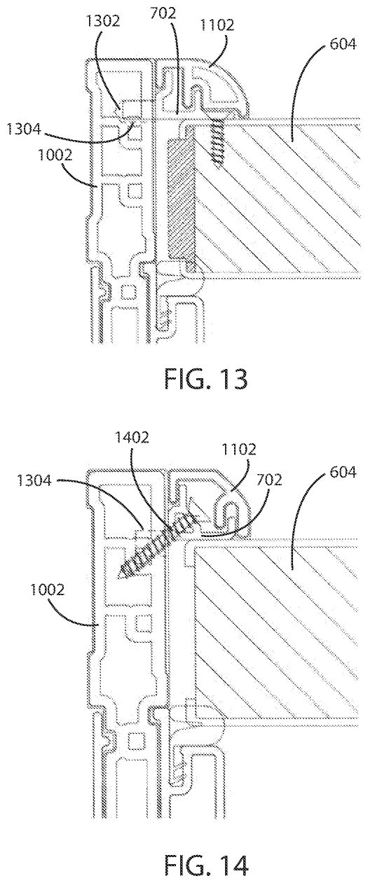

Various other modifications to elements herein are contemplated herein. For example, in some embodiments, the jamb panel clips 702 may lack the jamb retention hooks. Referring now to FIG. 13, a cross-sectional view of a panel 604 intersecting jamb members 1002 is shown in accordance with various embodiments herein. The system includes a plurality of jamb panel clips 702. In this embodiment, a projection from the jamb panel clips is included in the form of a pin 1302. The jamb members 1002 can include a receiving aperture 1304 to receive the projection or pin from the jamb panel clips 702. The projection or pin 1302 can interface with the receiving aperture 1304 to secure the jamb panel clips 702. As before, the fenestration system also includes a trim piece 1102. In some embodiments, the projection or pin 1302 can be substantially parallel with an interior or exterior surface of the panel. However, in other embodiments, the projection or pin 1302 can be angled with respect to an interior or exterior surface of the panel by about 5, 10, 20, 30, 45, 75 or 90 degrees, or an amount falling within a range between any of the foregoing.

In some embodiments, the jamb panel clips 702 can be fastened by passing a fastener through the jamb panel clip at an angle and into the frame member, such as the jamb member. This can be instead of, or in addition to, a fastener passing through the jamb panel clip and into the panel assembly. Referring now to FIG. 14, a cross-sectional view of a panel 604 intersecting a jamb member 1002 is shown in accordance with various embodiments herein. As before, the system includes jamb panel clips 702. The fenestration system also includes a plurality of jamb members 1002. The plurality of jamb members 1002 can include a receiving aperture 1304. The fenestration system also includes an angled fastener 1402. As such, in various embodiments, the fastener 1402 can be driven through the jamb panel clip 702 into the jamb member 1002 at an angle with respect to a surface plane of a panel. As before, the fenestration system also includes a trim piece 1102.

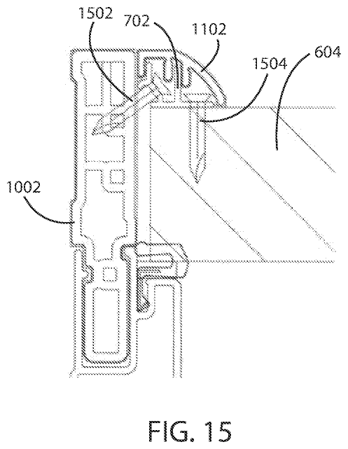

In some embodiments, fasteners can be driven into both the panel and the frame or jamb member. Referring now to FIG. 15, a cross-sectional view of a panel 604 intersecting a jamb member 1002 is shown in accordance with various embodiments herein. Jamb panel clips 702 can be attached to the panel and the jamb members 1002. In this example, the fenestration system also includes a first fastener 1502 and a second fastener 1504. The first fastener 1502 can be driven at an angle through the jamb panel clip 702 and into the jamb member 1002. The second fastener 1504 can be drive through the jamb panel clip 702 and into the panel 604. As with other embodiments, the fenestration system can also include a trim piece 1102.

While FIGS. 2-5 herein depict sill panel clips and/or sills, it will be appreciated that some embodiments herein may lack sills and sill panel clips entirely. For example, in the context of a transom panel, there would be no sill. Rather, the frame would include a first side jamb, a second side jamb, a bottom head jamb, and a top head jamb, and only jamb panel clips would be needed.

### Methods

Many different methods are contemplated herein, including, but not limited to, methods of making, methods of using, and the like. Aspects of operations described elsewhere herein can be performed as operations of one or more methods in accordance with various embodiments herein.

In an embodiment, a method for securing a panel within a fenestration frame assembly is included. The method can include attaching one or more sill panel clips onto a sill assembly, setting a panel assembly into an opening defined by the sill assembly and a plurality of jamb members thereby engaging the panel assembly with the one or more sill panel clips, and securing the panel assembly in the opening by fastening a plurality of jamb panel clips to the plurality of jamb members and the panel assembly.

In an embodiment of the method, setting the panel assembly into the opening can include pivoting the panel assembly into the opening defined by the sill assembly and the jamb members.

In an embodiment of the method, securing the panel assembly in the opening can include inserting a retention hook of the jamb panel clips into a slot of the jamb members and fastening the jamb panel clips to the panel assembly.

In an embodiment of the method, securing the panel assembly in the opening includes can include inserting a retention hook of the plurality of jamb panel clips into an inward facing slot on the plurality of jamb members and inserting a fastener through the plurality of jamb panel clips into the panel.

In an embodiment of the method, securing the panel assembly in the opening can include inserting a retention hook of a jamb panel clip into an inward facing slot on a jamb member, pivoting the jamb panel clip toward the panel to contact the panel, and inserting a fastener through the jamb panel clip into the panel.

In an embodiment of the method, securing the panel assembly in the opening can include inserting a projection of the jamb panel clips into a receiving aperture of the jamb members and inserting a fastener through the jamb panel clip into the panel.

In various embodiments, the method can further include attaching a trim piece to the jamb panel clips.

It should be noted that, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

As used herein, the recitation of numerical ranges by endpoints shall include all numbers subsumed within that range (e.g., 2 to 8 includes 2.1, 2.8, 5.3, 7, etc.).

The headings used herein are provided for consistency with suggestions under 37 CFR 1.77 or otherwise to provide organizational cues. These headings shall not be viewed to limit or characterize the invention(s) set out in any claims that may issue from this disclosure. As an example, although the headings refer to a “Field,” such claims should not be limited by the language chosen under this heading to describe the so-called technical field. Further, a description of a technology in the “Background” is not an admission that technology is prior art to any invention(s) in this disclosure. Neither is the “Summary” to be considered as a characterization of the invention(s) set forth in issued claims.

The embodiments described herein are not intended to be exhaustive or to limit the invention to the precise forms disclosed in the following detailed description. Rather, the embodiments are chosen and described so that others skilled in the art can appreciate and understand the principles and practices. As such, aspects have been described with reference to various specific and preferred embodiments and techniques. However, it should be understood that many variations and modifications may be made while remaining within the spirit and scope herein.

1. A fenestration system comprising:
a panel assembly;
a sill assembly; and
one or more sill panel clips;
wherein the one or more sill panel clips are disposed on an upper surface of the sill assembly;
wherein the one or more sill panel clips secure the panel assembly to the sill assembly;
a plurality of jamb members; and
a plurality of jamb panel clips, wherein the plurality of jamb panel clips secure the panel assembly to the plurality of jamb members.

2. The fenestration system of claim 1, the jamb members comprising:
receiving slots;
the plurality of jamb panel clips comprising
one or more jamb retention hooks; and
wherein the one or more jamb retention hooks are configured to fit within the receiving slots securing the plurality of jamb panel clips to the plurality of jamb members.

3. The fenestration system of claim 2, wherein a portion of the one or more jamb retention hooks are angled with respect to a bottom surface of the plurality of jamb panel clips by to 170 degrees.

4. The fenestration system of claim 1, the jamb panel clips comprising a trim retention element.

5. The fenestration system of claim 4, the trim retention element comprising a snap-fit mechanism.

6. The fenestration system of claim 4, the trim retention element comprising a dovetail snap fastener.

7. The fenestration system of claim 4, further comprising a trim piece, wherein the trim piece is engaged with the trim retention element.

8. The fenestration system of claim 7, the trim piece comprising a trim stop.

9. The fenestration system of claim 1, the panel assembly comprising:
a panel; and
a sill panel filler, wherein the sill panel filler is fastened to a bottom of the panel.

10. The fenestration system of claim 9, the panel comprising a stationary door panel.

11. The fenestration system of claim 1, wherein the one or more sill panel clips secure the panel assembly to the sill assembly preventing movement of a bottom of the panel assembly in a direction perpendicular to a lengthwise axis of the panel assembly.

12. The fenestration system of claim 1, the panel assembly comprising a central projection;
wherein the central projection is disposed on a bottom side of the panel assembly; and
wherein the central projection is configured to at least partially fit within the one or more sill panel clips.

13. The fenestration system of claim 12, the one or more sill panel clips comprising a raised stop member, wherein the raised stop member is configured to prevent movement of the central projection to the interior side of the sill assembly.

14. (canceled)

15. The fenestration system of claim 1, the jamb members comprising:
a receiving aperture; and
the plurality of jamb panel clips comprising a projection, wherein the projection is configured to be inserted into the receiving aperture.

16. The fenestration system of claim 15, the projection comprising a pin.

17. The fenestration system of claim 1, further comprising a fastener, wherein the fastener is driven through the jamb panel clip into the jamb member at an angle with respect to a plane of the panel.

18. (canceled)

19. The fenestration system of claim 1, wherein the plurality of jamb panel clips are formed of a metal, a polymer, or a composite.

20. The fenestration system of claim 1, wherein the one or more sill panel clips are formed of a metal, a polymer, or a composite.

21. The fenestration system of claim 1, wherein the fenestration system lacks fasteners passing through the plurality of jamb members and into the panel assembly.

22-35. (canceled)

36. A fenestration system comprising:
a panel; and
one or more jamb members, the one or more jamb members comprising one or more receiving slots;
one or more jamb panel clips, wherein the one or more jamb panel clips secure the panel to the one or more jamb members, the one or more jamb panel clips comprising
one or more jamb retention hooks; and
wherein the one or more jamb retention hooks are configured to fit within the one or more receiving slots securing the one or more jamb panel clips to the one or more jamb members.

37-70. (canceled)
